(19) United States
(12) Patent Application Publication
(10) Pub. No.: US 2003/0218064 A1
(43) Pub. Date: Nov. 27, 2003

(54) Multi-purpose personal portable electronic system

(75) Inventors: Finis Conner, Carmel, CA (US); Anil Nigam, Saratoga, CA (US)

Correspondence Address: Townsend and Townsend and Crew LLP, 8th Floor, Two Embarcadero Center, San Francisco, CA, 94111, US

(73) Assignee: StorCard, Inc., Carmel, CA

(21) Appl. No.: 10/384,385

(22) Filed: Mar. 7, 2003

Related U.S. Application Data
(60) Provisional application No. 60/365,053, filed on Mar. 12, 2002.

(51) Int. Cl. G06K 7/00

(52) U.S. Cl. 235/439

(57) ABSTRACT

A portable electronic device includes a housing, a display area provided on one side of the housing, and a slot configured to receive an approximately credit card sized card. The card has a first semiconductor device provided at a first location on the card and a storage area provided on a second location on the card. The first semiconductor and storage area are coupled to each other for data transfer by a data path.

### CROSS-REFERENCES TO RELATED APPLICATIONS

The present application claims priority from U.S. Provisional Patent Application No. 60/365,053, filed on Mar. 12, 2002, which is incorporated by reference.

### BACKGROUND OF THE INVENTION

This invention relates to portable electronic devices that are used to process data including viewing text and playing audio and video files.

The current state of the art is to provide an MP3 player with 64 MB to 5 GB of non-volatile memory to store 12 to 1000 songs. The unit, however, functions only as a music player. There is another device with a screen and a DVD player in the form factor of a Notebook computer that can be utilized to view movies.

Video game players are separate devices that utilize vendor unique storage with specific controls, but do not provide any other functionality. Portable equipment such as a cell phone provide communication services, and a Personal Digital Assistant (PDA) or Pocket PC function as a personal organizer, appointment diary, and can be used to send and receive emails.

New gadgets are appearing in the market place that utilize GPS frequencies and storage to provide local information such as, restaurant lists, shopping malls locations and driving directions. Consequently, one would need an MP3 Player to listen to music, another device to view video, a separate one for games, a cell phone for communication and another unit to function as a diary and contact list, which would be inconvenient,

### BRIEF SUMMARY OF THE INVENTION

The present invention relates to a device, which can provide a plurality of functions in a single portable electronic system. In one embodiment, the portable system includes a host device and a “guest” device having a high capacity storage mechanism. The guest device is provided with in the shape and form factor of a credit card. This card when inserted into the host device configures the host device to function as a MP3 player, a video recorder or player, a cell phone, a GPS direction finder or a PDA according to the specific configuration of the card. One or more guest devices or cards can be carried conveniently in a wallet or shirt pocket.

Another feature of the subject invention is that it has a security device, whereby, a thumb print sensor is constructed in the unit to allow user authentication to be performed for secure content viewing. Additional security could include speech recognition, other types of biometrics and passwords.

In one embodiment, a portable electronic device includes a housing, a display area provided on one side of the housing, and a slot configured to receive an approximately credit card sized removable card. This card has a first semiconductor device provided at a first location on the card and a storage area provided on a second location on the card. The first semiconductor and storage area are coupled to each other for data transfer by a data path.

In one embodiment, a multi-functional portable electronic device includes a housing, a display area provided on one side of the housing, and a slot configured to receive a card having a first semiconductor device provided at a first location on the card and a storage area provided at a second location on the card. The first semiconductor and storage area are coupled to each other for data transfer by a data path. The card is configured to provide an application specific function. The device is configured to provide a function according to the application the card needs to satisfy when it is inserted into the slot.

In another embodiment, an authentication card associated with a specific user includes identification information of the specific user; an integrated circuit accessible from an exterior of the card, the integrated circuit being provided on a first location on the card; and a storage area provided on a second location on the card that is remote from the first location.

In yet another embodiment, a method for using a card-like device includes inserting the card-like device into a host device, the card-like device having an integrated circuit provided on a first location of the card-like device and a storage area provided on a second location of the card-like unit that is remote from the first location, an application program being stored in the storage area of the card-like device, the card-like device having a thickness of no more than 0.25 inch; and the capability to process information using the application program stored in the card-like device as an input device to the host device.

### BRIEF DESCRIPTION OF THE DRAWINGS

FIG. 1 illustrates a top view of one embodiment of the portable digital file viewer according to one embodiment of the present invention.

FIG. 2 shows a front view of the viewer of FIG. 1.

FIG. 3 shows a side view of the viewer of FIG. 1.

FIG. 4 shows a top view of a digital viewer with internal component details according to one embodiment of the present invention.

FIG. 5 is a side view illustrating the location of a finger print sensor provided on the digital viewer.

FIG. 6 is a side view showing the location of the on/off switch and firewire or USB connector.

FIG. 7 is a bottom view of the digital viewer illustrating the charging and cradle interface connections.

FIG. 8 is a front view of the digital viewer illustrating a slot where a storage card can be inserted.

FIG. 9 illustrates a storage card as partially inserted into the digital viewer.

FIG. 10 is a side view of the digital viewer with a storage card partially inserted into the digital viewer.

FIG. 11 is a top view of the digital viewer with a storage card in an operating position.

FIG. 12 is a side view of the viewer of FIG. 11.

FIG. 13 is a front view of the viewer of FIG. 11.

FIG. 14 is a top view of a storage card reader mechanism according to one embodiment of the present invention.

FIG. 15 is a side view of the storage card reader mechanism of FIG. 14.

FIG. 16 is a plan view of a storage card with internal details according to one embodiment of the present invention.

FIG. 17 is a side view of the storage card of FIG. 16.

FIG. 18 is a front view of the storage card of FIG. 16.

FIG. 19 is a plan view of a storage card with a plurality of semiconductor devices including logic devices according to one embodiment of the present invention.

FIG. 20 is a side view of the card of FIG. 19

FIG. 21 is a plan view of a storage card with a Flash memory device as a storage volume according to one embodiment of the present invention.

FIG. 22 is a bottom view of a storage card with a Flash memory device as a storage volume and a high speed interface according to one embodiment of the present invention.

FIG. 23 is a bottom view of a storage card with a Flash memory device as a storage volume, a high speed interface, and a plurality of semiconductor devices including logic devices according to one embodiment of the present invention.

FIG. 24 shows a functional block diagram of the card of FIG. 23 according to one embodiment of the present invention.

FIG. 25 shows a functional block diagram of the card of FIG. 23 according to another embodiment of the present invention.

FIG. 26 is an exploded view of a symmetric card with an external shutter system according to one embodiment of the present invention.

FIG. 27 is a top view of the card of FIG. 26 with the top shutter in the closed position.

FIG. 28 is a bottom view of the card of FIG. 26 with the shutter in the closed position.

FIG. 29 is a top view of the card of FIG. 26 with the shutter in the open position.

FIG. 30 illustrates a recording disk and hub arrangement according to one embodiment.

FIG. 31 shows a sectional view of the card of FIG. 26 and spindle motor configuration.

FIG. 32 illustrates an external shutter arrangement of the card of FIG. 26.

FIG. 33 illustrates the attachment details of the shutter construction of FIG. 32.

FIG. 34 shows a plan view of an ISO 7816 implementation of the card of FIG. 26.

FIG. 35 illustrates defection of an ISO Card in a transverse direction.

FIG. 36 illustrates defection of an ISO Card in a longitudinal direction.

FIG. 37 illustrates a block diagram of a card having a cryptographic logic according to one embodiment of the present invention.

FIG. 38 shows a portable electronic system including a host computer and a storage card as a guest device according to one embodiment of the present invention.

FIG. 39 is a plan view of another embodiment of a digital viewer according to another embodiment of the present invention.

FIG. 40 is a side view showing the location of the finger print sensor on the viewer of FIG. 39.

FIG. 41 is a bottom view of the viewer showing a charging and interface connector on the viewer of FIG. 39.

FIG. 42 is a front view showing a slot for the storage card on the viewer of FIG. 39.

FIG. 43 is an isometric view of the viewer.

FIG. 44 is a block diagram of electronics in the digital viewer and the storage card according to one embodiment of the present invention.

FIG. 45 illustrates a side view of a digital viewer and a removable medium with the function specific electronics partially inserted into the viewer according to one embodiment of the present invention.

FIG. 46 is a plan view the digital viewer and removable medium of FIG. 46.

FIG. 47 illustrates a side view a digital viewer and a storage volume of small form factor hard disk drive according to another embodiment of the present invention.

FIG. 48 illustrates a plan view of the digital viewer and storage volume of FIG. 45.

FIG. 49 is a plan view of an embodiment as a storage subsystem according to one embodiment of the present invention.

FIG. 50 is a front view of the storage subsystem of FIG. 49 showing a card insertion slot.

FIG. 51 is a side view of the storage subsystem of FIG. 49 showing an eject button.

FIG. 52 illustrates a plan view of a storage subsystem with a wireless interface option according to one embodiment of the present invention.

FIG. 53 shows a card insertion slot provided at the front of the wireless interface storage subsystem of FIG. 52.

FIG. 54 shows a side view of the storage subsystem of FIG. 52.

### DETAILED DESCRIPTION OF THE INVENTION

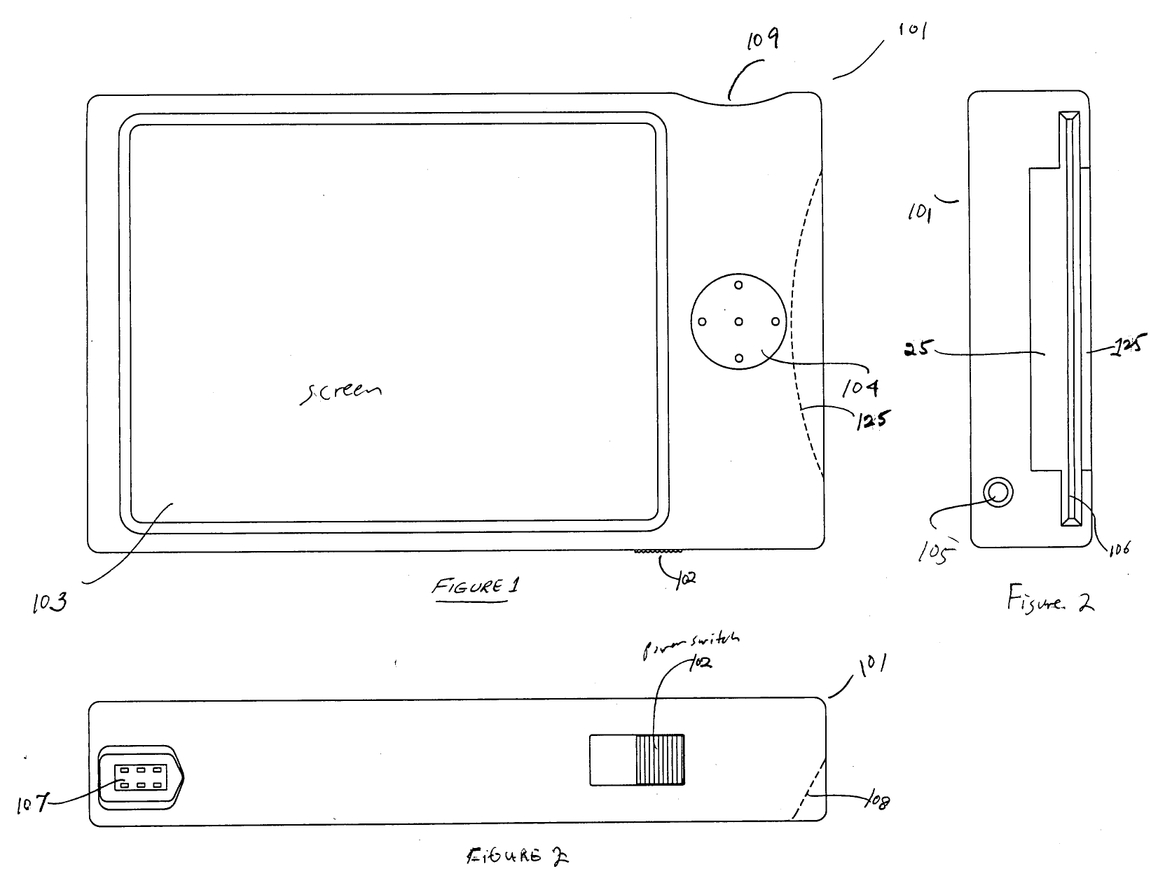

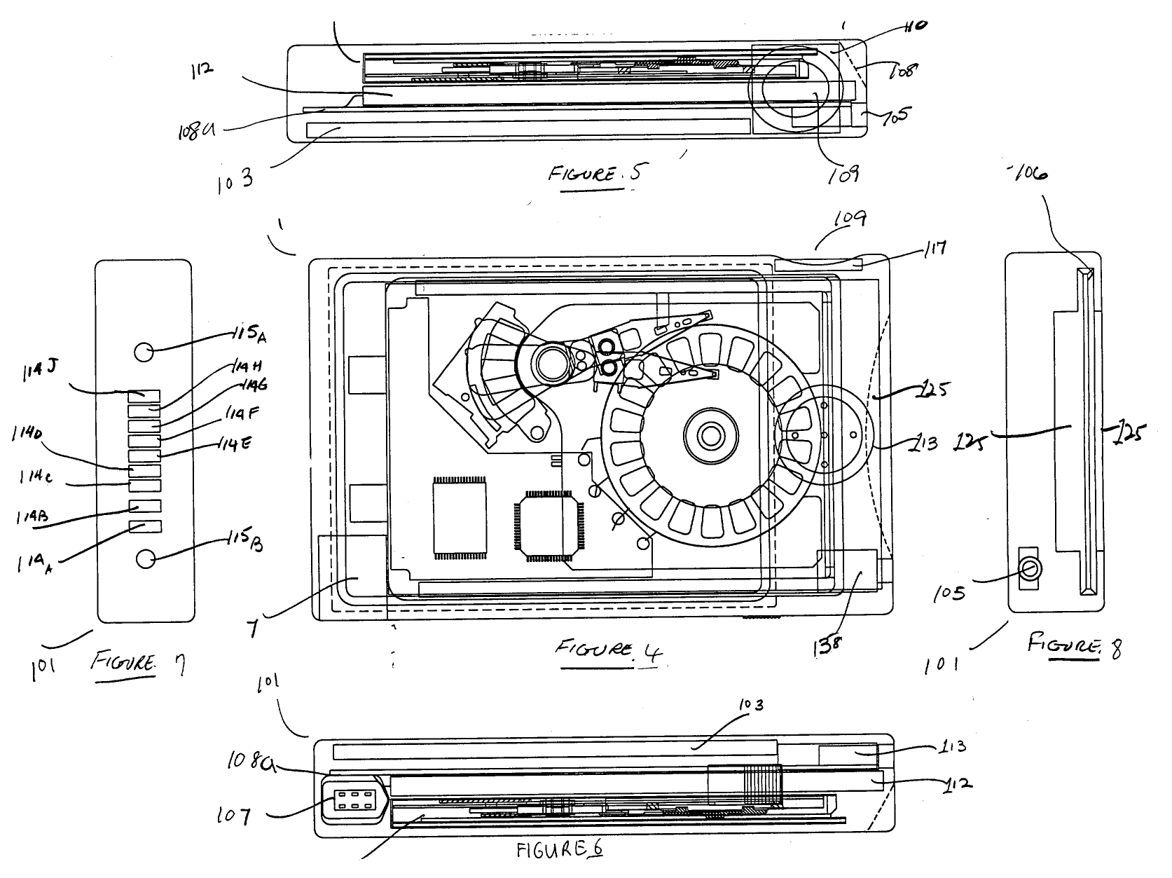

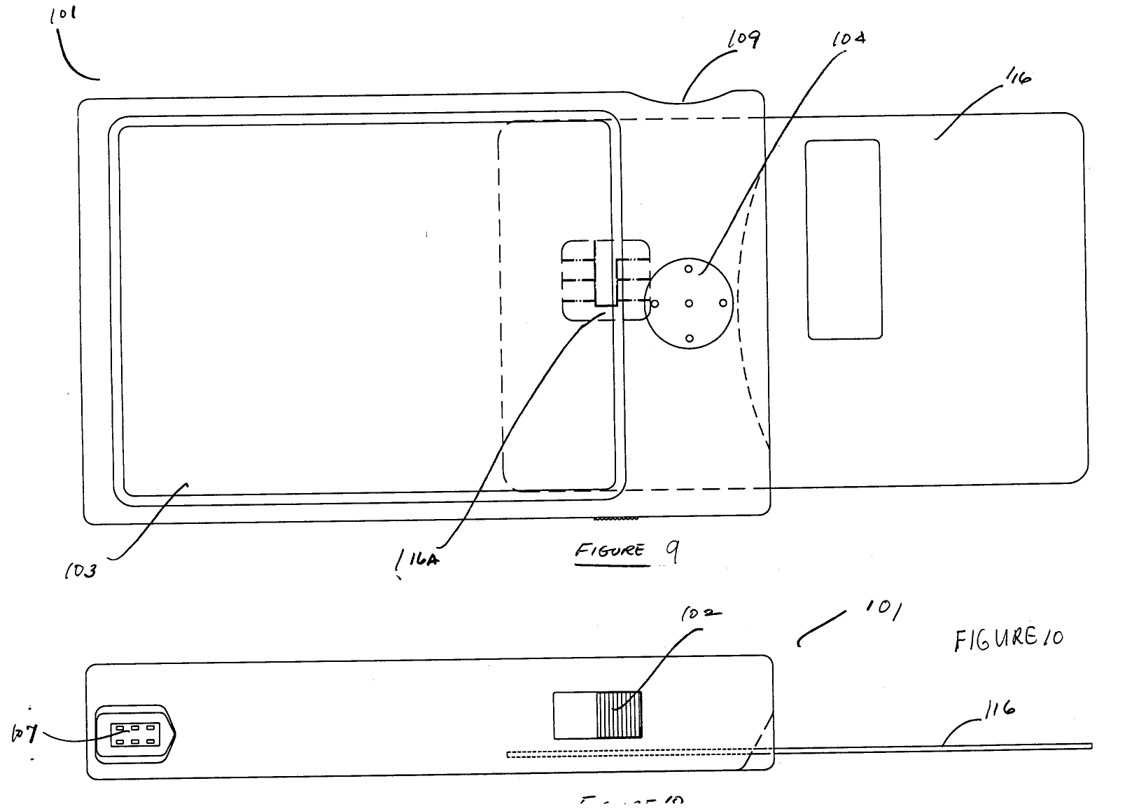

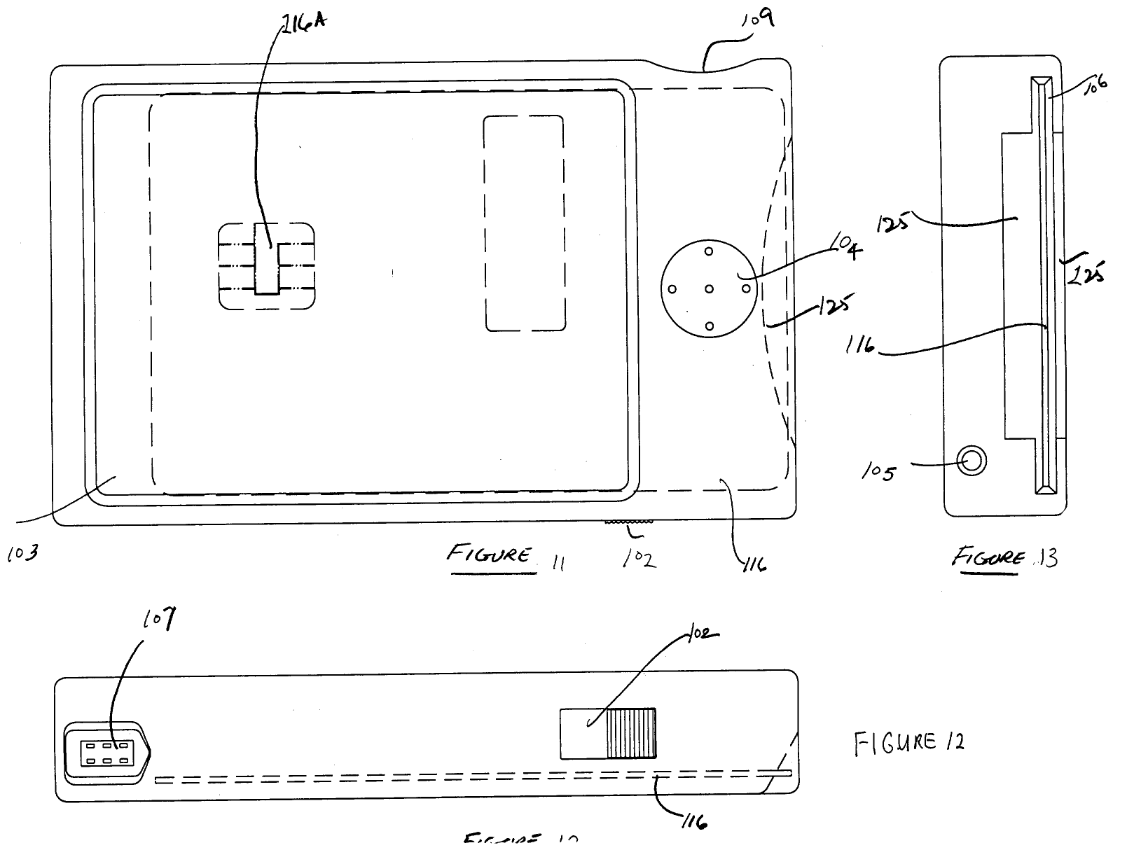

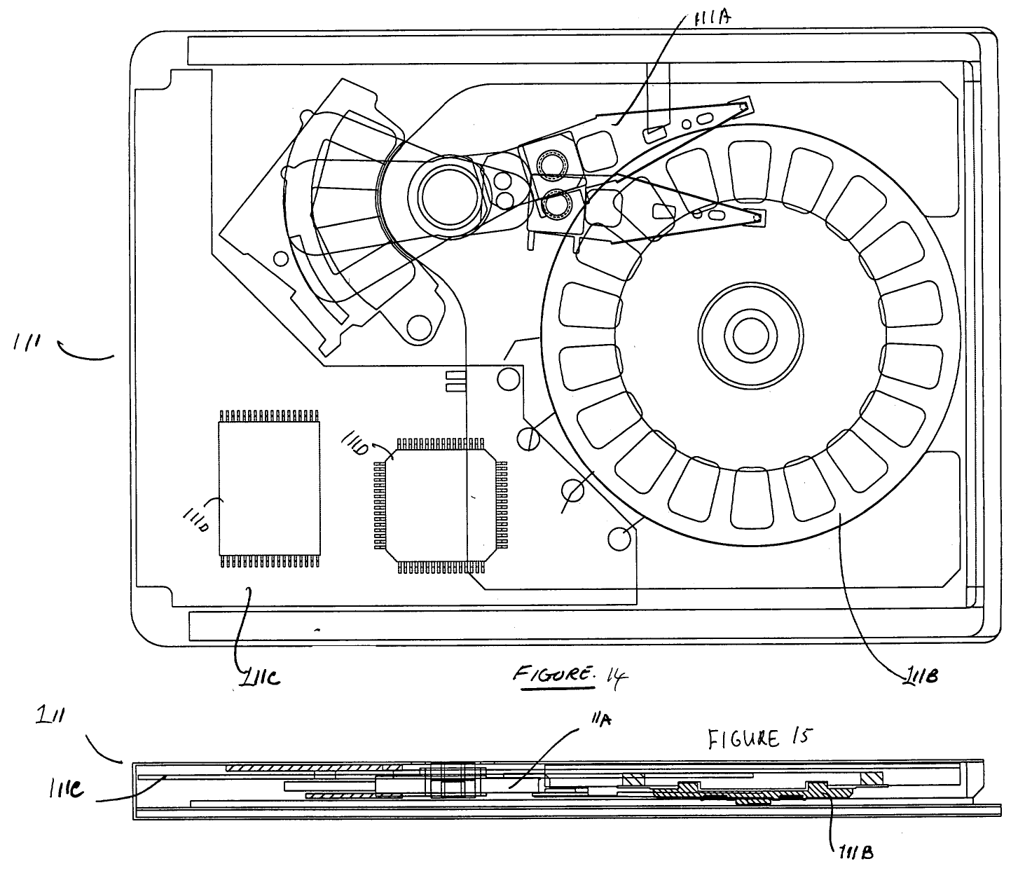

FIG. 1 shows in plan view one embodiment of the subject invention. A portable host device 101 for processing data in cooperation with a guest device 116 (see FIG. 9). Host device 101 is made from a high impact plastic or structural form material and has approximate dimensions of 4.0 inch long, 2.43 inches wide and 0.65 inch tall according to one embodiment. It has a screen 103 with a viewing area having a diagonal dimension of 3.5″, a speaker unit 104, a power switch located on one side 102, a thumb print sensor 109 located on the opposite side for a right handed user. A separate unit may be required with mirrored switch and senor positions for a left-handed user. Other embodiments with the finger print sensor located at another position can also be constructed to avoid this type of customization.

FIG. 2 shows the front of this unit, where a stereo headphone jack 105 is located. The guest device or storage card 116 is a inserted in a slot 106. A concave volume or cutout 125 is provided to allow easy access to this card.

FIG. 3 shows a side view of the host device 101 with the power switch 102 and USB or 1394/firewire connector 107. A dashed line 108 is the inner boundary for the cutout 125. The portion of host 101 on either side of slot 106 is made such that the storage card 116 when fully inserted into the host would be behind this surface and thereby all impacts would be incident on casing 101 and not to storage card 116.

FIG. 4 illustrates the internal details of host device 101 (or the digital viewer) in plan view according to one embodiment of the present invention. FIGS. 5, 6, 7 and 8 show the sensor side view, the power switch side view, the bottom view and the front view of host device 101, respectively. Screen 103 is a TFT device, such as, NEC's NL2432DR22, and is located slightly below the top of 101 to provide scratch protection. Below the screen is a PCB 108 that houses the electronics for the unit. Behind the PCB is a lithium polymer rechargeable battery 112, such as, Sony model UP325385A. Battery 112 is connected to PCB 108 and is charged when host device 101 is positioned onto a charging module (not shown). Battery charging is done by contact pads 114A and 114B.

The digital viewer 101 is located on the charging module by holes 115A and 115B. Contacts 114C to 114J allow interfacing the digital viewer to a Personal Computer. The USB or firewire connector is surface mounted to PCB 108, along with speaker 113 and headphone jack 138. The USB connector can be utilized to record and playback video and audio files or for high-speed communication with another computer or electronic appliance. The finger print sensor 117 is located in a cavity formed in viewer 101 to provide structural rigidity and is connected to PCB 108 by a printed circuit cable (not shown). The casing of the digital viewer 101 has a cutout, 109, to allow the thumb to be positioned over sensor 117 when the device is held in the left hand. This sensor has 500 dpi resolution and develops a map of the user's finger print pattern. A microprocessor 130 (FIG. 44) located on PCB 108 can interrogate this sensor and compare the thumbprint biometric to that stored in card 116 to satisfy the security criteria for the content being viewed on viewer 101. Storage card 116 when inserted into viewer 101 gets positioned in a reader mechanism 111. This mechanism will be described later in this disclosure.

FIG. 9 shows the plan view of the digital viewer with the storage card 116 partially inserted into the unit. Storage card 116 contains an integrated circuit 116A that houses electronics to program the functionality of digital viewer 101. FIG. 21 is the side view of viewer 101 showing the location of the storage card 116.

FIGS. 11-13 show digital viewer 101 with the storage card 116 in the operating position. The integrated circuit 116A interfaces with a standard Smart Card IC connector such as CCM04-1889 sold by ITT Cannon Industries, Eden Prairie, Minn., USA and located in the reader mechanism 111 (not shown). The position of the storage card 116 is shown in FIG. 12 with its front located behind the wall of the casing. Storage card 116 is manually inserted until it locks in the reader mechanism 111. Gaskets are provided in front of the reader mechanism to wipe the card and protect contaminants from entering this mechanism. To eject this card, it is pushed in again similar to the action of a ballpoint pen. A stereo headphone can be connected to headphone jack 105. This headphone jack can make connections to the speaker contacts of 138 or to the speaker and the microphone contacts depending upon the design of the specific jack. In other embodiments the headphone connector can provide both an audio player and microphone for cell phone functions.

FIGS. 14 and 15 show details of reader mechanism 111. A PCB 111C is connected to PCB 108 by a flexible cable (not shown). PCB 111C has a DSP and control logic to operate spindle motor 111B to rotate the disk contained in card 116 at high speeds, control the position of recording arm 111A, transfer and record digital information to the disk. PCB 111C includes a plurality of semiconductor devices 111D. These devices may be a processor, RAM, ROM, logic devices, and the like. The recording arm can be moved rapidly, average access time less than 15 milli-second, to any track on the storage volume. A more detailed description of the reader mechanism 111 is provided in U.S. patent application Ser. No. 10/193,824, filed on Jul. 11, 2002, assigned to the assignee of the present application, which is incorporated by reference. In one embodiment, the reader is a portable device in the form of a PC card or PCMCIA card.

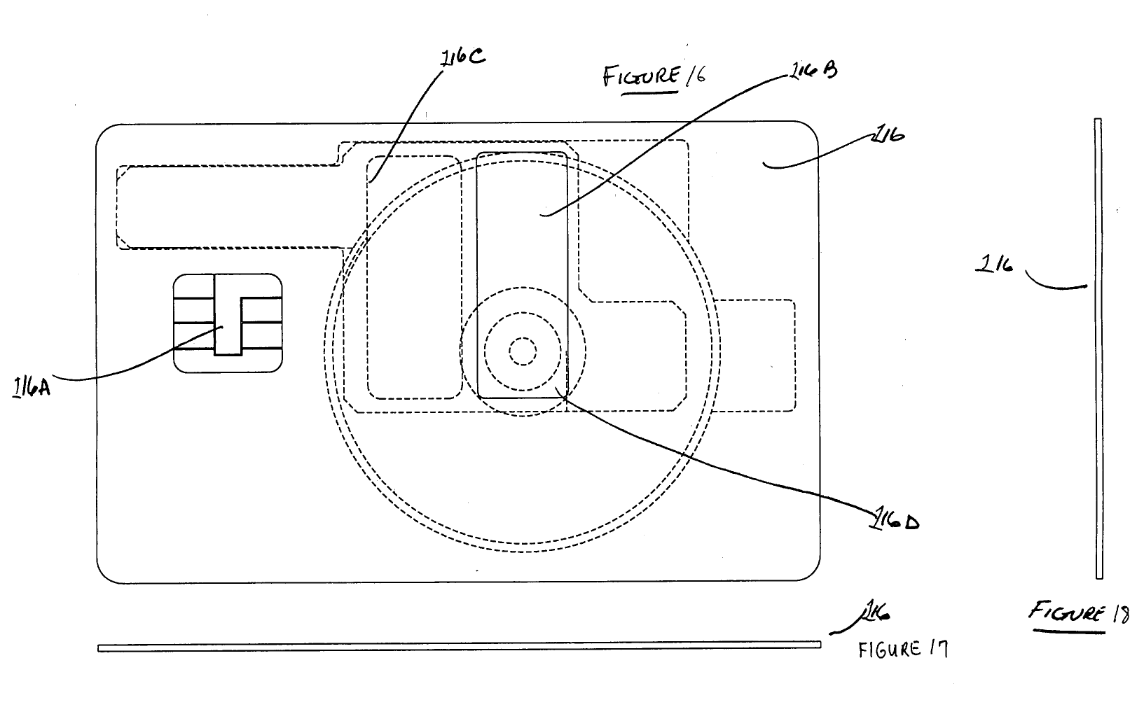

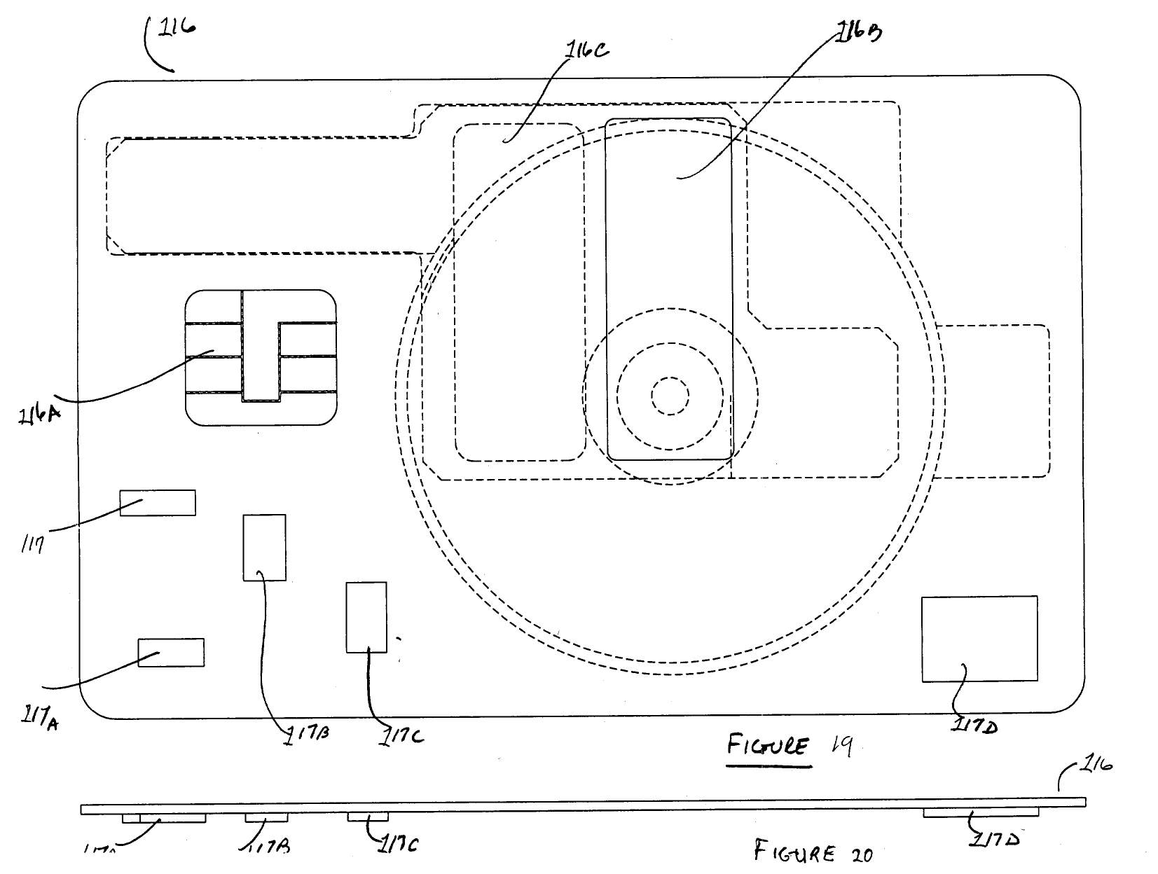

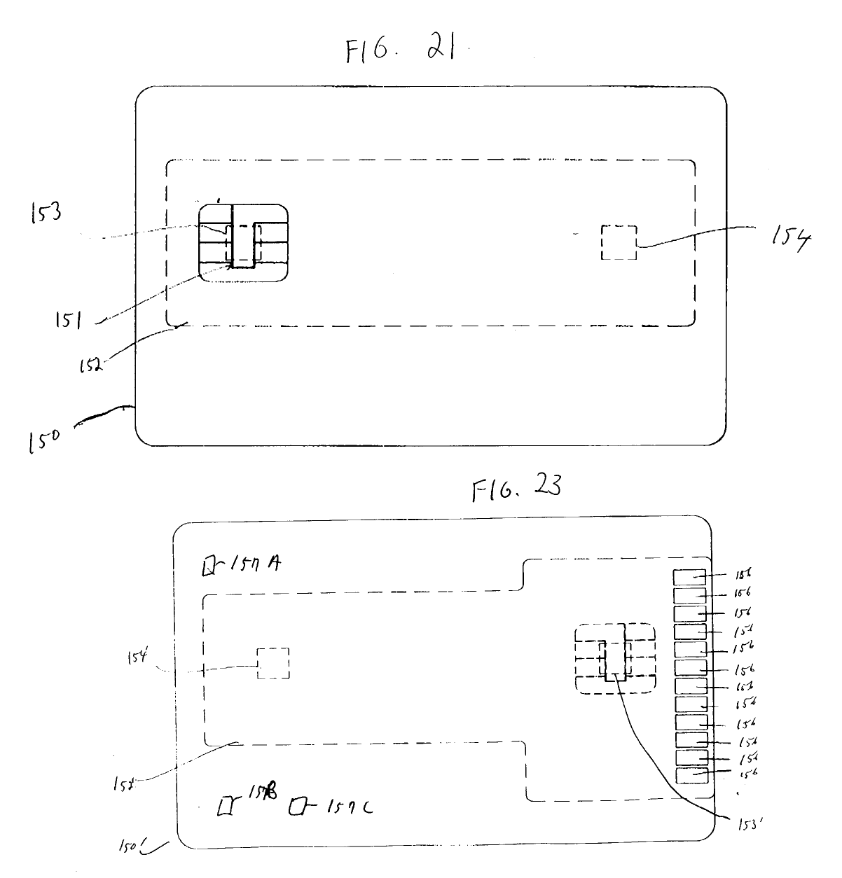

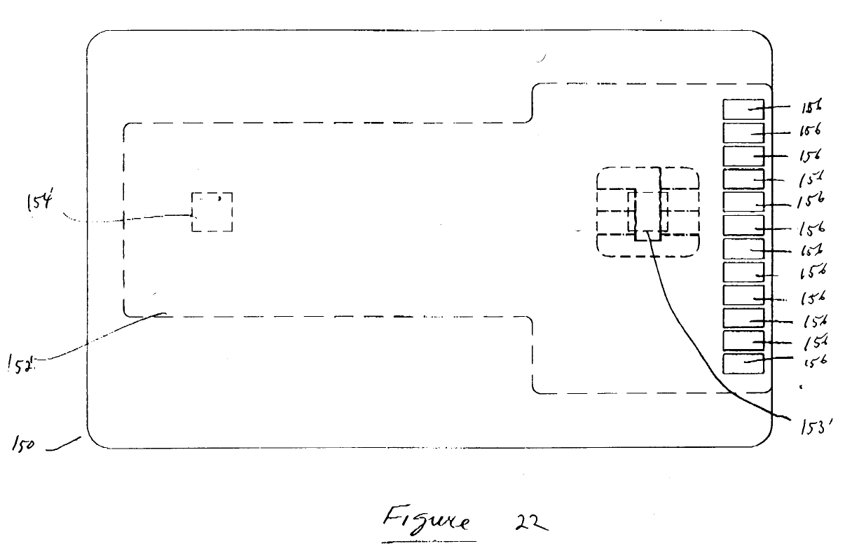

FIGS. 16-18 show a plan view, side view and front view of storage card 116, respectively. The card has a shutter that is actuated when it is inserted into digital viewer 101 moving the opening 116C into position 116B. This opening allows the recording head mounted on recording arm 111A to access the disk contained in 116. Hub 116D in the operating position of storage card 116 interfaces with spindle motor 111B. A magnetic chuck and a centering pin locate the disk in 116 concentric with the rotational axis of spindle motor 111B. When storage card 116 is pushed in again, the mechanism in reader 111 disengages hub 116D from the spindle chuck plate 111B and ejects storage card 116 out of digital viewer 101. In this embodiment storage card 116 has a single integrated circuit 116A. In another embodiment as shown in FIGS. 19 and 20 discrete electronic components and integrated circuits 117, 117A, 117B, 117C and 117D, such as RAM, ROM, digital logic and/or a processor, are located on the card and interconnected with a flexible circuit cable. Electronic components 117 to 117D are located in an area where in legacy credit cards there is embossed lettering. It is then possible to realize these electronic components within the form factor of the ubiquitous credit card.

In another embodiment, as shown in FIG. 21, a credit card 150 is shown with a IC 153 conforming to ISO 7816. In one embodiment, the size of the IC die 153 is no more than about 25 mm². This IC die is encapsulated and attached to a module 151 which provides the interconnects defined in ISO 7816. In this figure another semiconductor die 154 is shown at another location on credit card 150. This location may be a mirror image of the position of the IC die 153. The die 154 is a Flash memory device in the present embodiment, but may also be other types of non-volatile memory or digital logic. Flash manufacturing technology using a 0.12 micron process can realize a 1 Gbit device in a 135 mm2² die. Utilizing the same process and a 25 mm² die size a storage capacity of about 190 Mbits or 23 MBytes can be attained. Improvements in semiconductor processing will result in even larger storage capacities being achieved in a 25 mm² die package, which is an upper limit specified for an ISO 7816 compatible IC. In this embodiment, the IC die 154 is mounted in a similar manner as the Smart Card IC 153. The two ICs are inter-connected with a flexible circuit 152 made from Kapton or other plastic material with electrical traces deposited on the Kapton substrate. In one embodiment, the IC 153 controls access to the primary storage IC 154 and communicates via the ISO 7816 bus.

In another embodiment electrical conductors may be deposited on the plastic top or bottom covers, or both, and the entire assembly is encapsulated within the top and bottom layer of the card. This device should meet the flexibility specifications of a Smart Card as both ICs are in similar positions with respect to the bending/deformation requirements of ISO 7816. Other configurations with larger Flash dies could be utilized. These latter cards may not meet the flexibility requirements of ISO 7816 and could be semi-rigid or rigid units.

The dimensions of card 150 may vary according to applications. For example, the card can be thicker, or configured with a smaller foot-print as desired. The ISO 7816 specification requires the card to have approximate dimensions of 3.37 inch by 2.125 inch by 0.03 inch. However, the cards described in this disclosure could have a thickness anywhere in the range from 0.25 inch to 0.020 inch according to one embodiment of the present invention. In another embodiment, the card can be configured with a thickness in the range from about 0.020 inch to about 0.04 inch to allow the card to fit sleeves in personal wallets. Additionally, ISO specifies the card to have a length of 3.37 inch, other embodiments can be constructed with card lengths that are in the range from 0.5 inch to 4 inches. The width of the card per ISO specifications is 2.125 inch, and embodiments can be realized with widths that are in the range from 0.5 inch to 3.0 inches.

FIG. 22 shows a bottom face of a card 150′ according to another embodiment of the present invention. The card includes a first IC 153′ corresponding to IC 153 of FIG. 21 and a second IC corresponding to IC 154 of FIG. 21. A flexible cable 152′ interconnects the two ICs 153′ and 154′ as described earlier. A high speed interface 156 is provided on the bottom face of the card. In the present implementation, twelve pins are shown. One advantage of the 12 pin interface being located in the backside of the card is that the front face can have artwork similar to credit cards that is printable with similar equipment. In this embodiment the card has two interfaces, one to communicate via the ISO7186 interface located on the front face of the card and via the 12 pin interface 156 located at the back of the card. The data throughput via the 12 pin interface can be made much faster, to provide greater functionality.

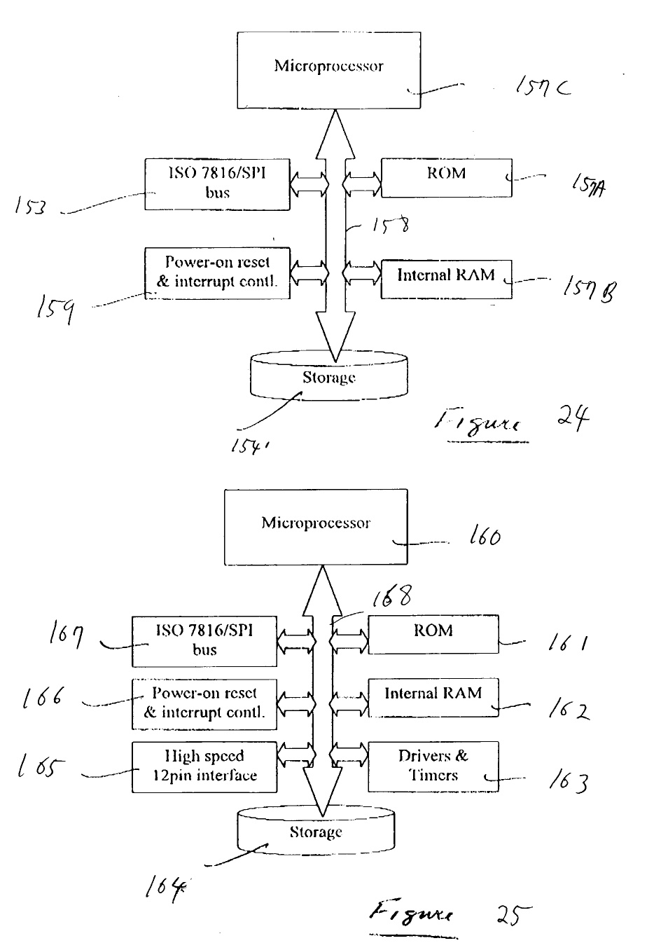

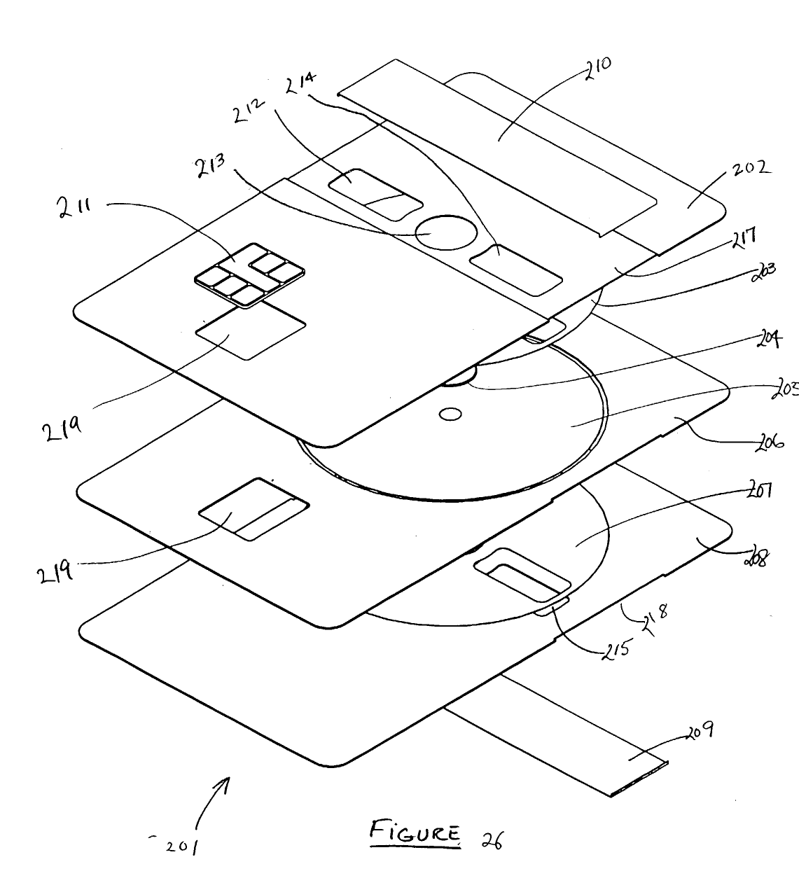

In one embodiment, card 150′ is provided with a plurality of semiconductor devices 157A-157C, FIG. 23. The semiconductor devices includes a ROM 157A, a RAM 157B, and a processor 157C that are interconnected by a bus 158 (FIG. 24). The card also includes a ISO 7816/SPI bus 153 and a power-on reset and interrupt control logic 159, as illustrated by FIG. 24. One or more applications may be stored in the ROM 157A or the storage or flash memory 154′. Other functional blocks can also be realized such as shown in FIG. 25 or to meet specific product requirements. That is, the card includes a microprocessor 160, a ROM 161, a RAM 162, drivers and timers 163, a storage (flash or magnetic memory) 164, a high speed interface 165, a power-on reset 166, an ISO/SPI bus 167, and a bus 168 interconnecting these components.

FIG. 26 illustrates a guest device or card 201 formed from a series of layers. Card 201 corresponds to the card 116 that is configured to be used with host device 101 in FIG. 1. In one embodiment, the card is provided with a form factor of a credit card that is configured to comply with the ISO 7816 standard. ISO 7816 is an internationally accepted standard for the size of credit cards, their flexibility, arrangement of information, and other features. The thickness of the card 201 is approximately 0.031 inches. Its length and width are about 3.37 and 2.125 inches, respectively. The top layer 202 is formed from a sheet of 300 stainless steel that is about 0.005 inches thick. There is a step down in thickness in this layer of about 0.0025 inches for a length of about 0.906 inches, 217, where a shutter 210, also of 300 stainless steel approximately 0.0025 inches thick, slides. As will be described, the shutter 210 is configured to selectively covers openings 212, 213 and 214.

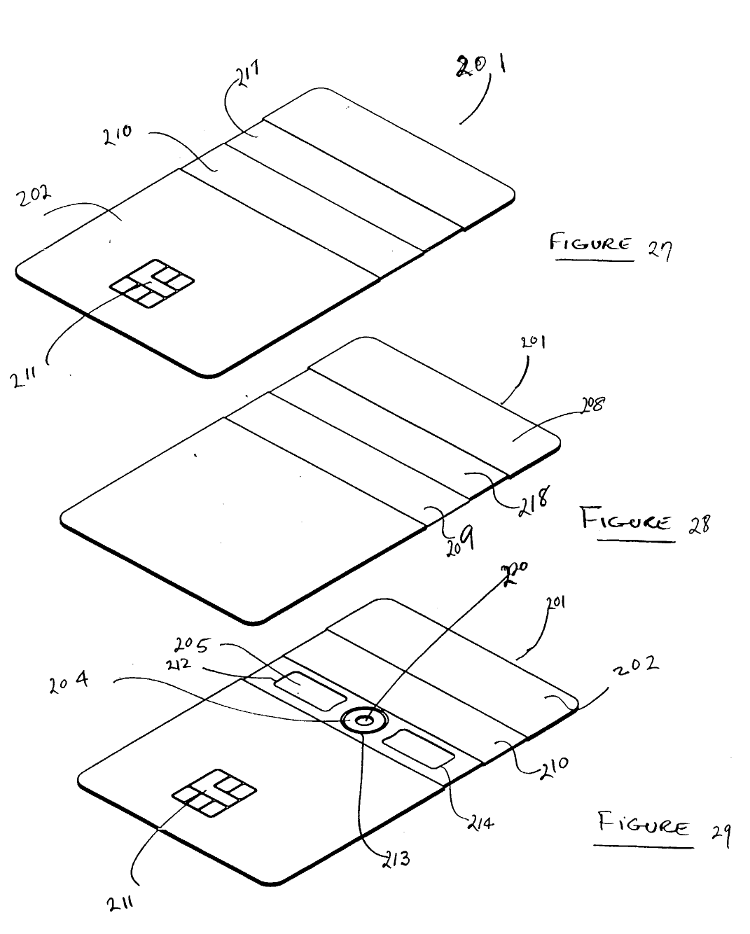

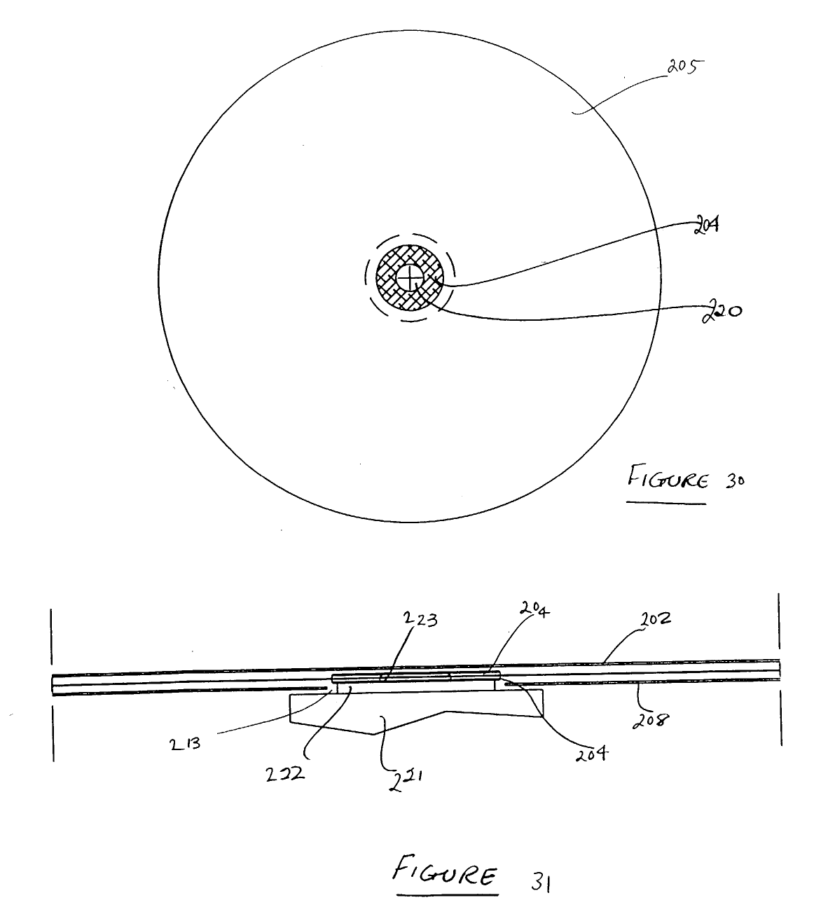

This card is constructed with a layer 202 laminated with layers 206 and 208. Layer 208, like layer 202, is formed from 300 stainless steel to provide a lower thickness area 218 where shutter 209 slides. Layer 206, preferably PVC plastic, has a circular opening where a magnetic disk 205 is housed. A hub 204 approximately 0.010 inches thick is attached to both sides of the disk 205 (see discussion in conjunction with FIGS. 27 and 28). Preferably, magnetic disk 205 is a disk with a Mylar substrate and at least a magnetic film coated on one surface of the substrate, such as used in existing ZIP and floppy diskettes. Alternatively other materials may be used. For example, the disk may also be made from stainless steel, which is polished and sputter coated as described in U.S. Pat. No. 5,968,627 or U.S. Pat. No. 6,113,753. In this case, the disk is approximately 0.0008 inch thick, and preferably has high coercivity magnetic films sputter deposited on both sides. Identical coatings on both surfaces of the disk cause it to remain normally flat. The magnetic films and surface treatment is similar to that utilized on contemporary hard disk storage products.

The current state of the art, for this magnetic film technology, is 20 Gbits/in² area recording density. Disk 205 and the hubs 204 are free to rotate in a cavity created in layer 206 of about 0.017 inch thickness. The disk diameter is about 1.772 inches and the circular hole in layer 206 is made approximately 0.05 inches larger diametrically. Two liners 203 and 207, made from, in one embodiment, lens cleaning tissue about 0.0015 inch in thickness and in other embodiments non-woven fabric sheets that are about 0.003 inch thick, are attached to layers 202 and 208 such that they face the surfaces of disk 205. Other embodiments of the disk 205 utilize a Mylar substrate and a slurry coated magnetic film such as a high capacity floppy disk or sputter coated substrates which includes glass, ceramic, Aluminum or Titanium.

In some embodiments, a “Smart Card” type chip 211 is affixed (e.g. glued) in the cavity created by openings 219 provided in layers 202 and 206. Of course, other card configurations without a chip are also possible. In one embodiment, the chip manages or controls access to the disk including requiring authentication prior to allowing access to the disk. The completed card is shown in top view in FIG. 27, and in bottom view in FIG. 28. The shutters 210 and 209 selectively cover slots 212, and 214 created in layers 202 and 208. When these slots are uncovered, a recording head in the reader can access disk 205 surfaces for data recording, and the spindle motor chucking surface 222 (FIG. 31) can engage hub 204 through slot 213. The spindle motor 221 itself is located in the reader.

One function which occurs when the card is inserted into the reader is that a pawl in the reader engages with the shutters 209 and 210 (FIGS. 27 and 28) sliding them to uncover openings 212, 213 and 214. Upon further insertion into the reader, the shutters are fully opened and a magnetic chuck 222 in the reader's spindle motor 221 contacts the hub 204. Hub 204 is made of magnetically soft material and is attracted to the spindle motor chucking surface 222, containing a permanent magnetic. The hole 220 in hub 204 is centered onto the spindle rotor shaft 223. The top and bottom layers of the card are supported in the reader in a manner similar as illustrated in FIG. 31, to provide a cavity that is approximately 0.017 inch. The card construction discussed above is referred to herein as symmetric because the card can be removed, inverted, and re-inserted into the reader for data to be accessed utilizing a single recording head assembly.

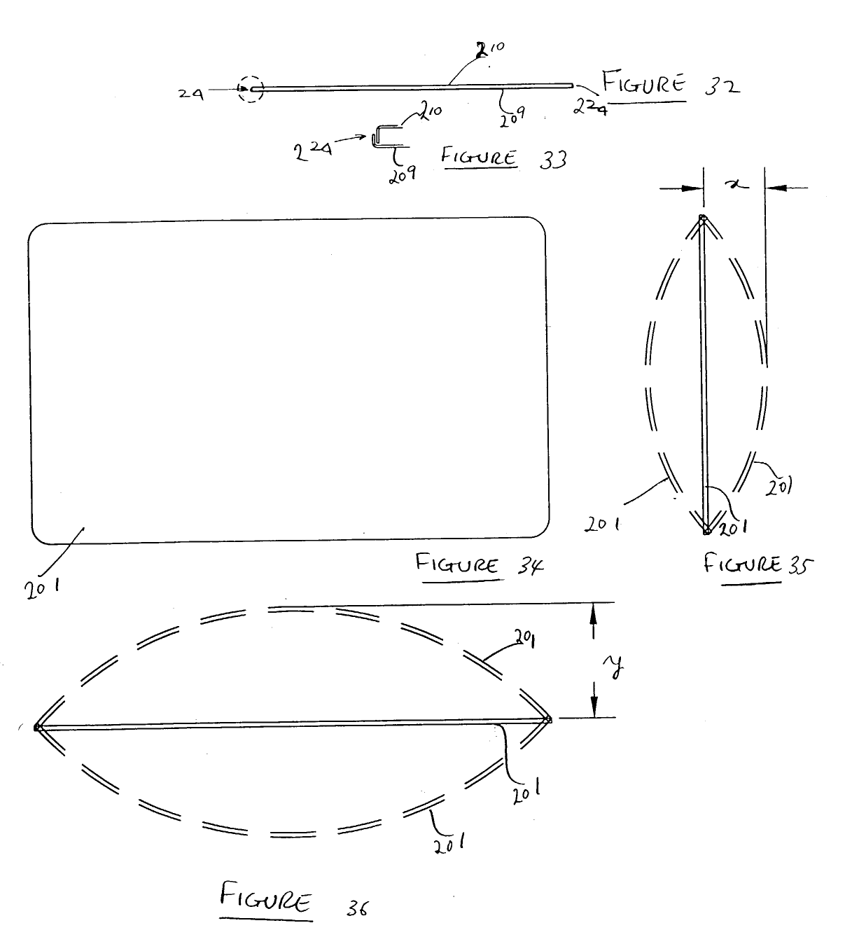

FIG. 32 illustrates the construction of the shutter. The shutter 210 and the shutter 209 overlap as shown in FIG. 33. This overlap is formed with the card body between the shutters as the final assembly (for clarity the card body is not shown in FIGS. 32 and 33). These shutters are then spot welded or laser welded on the sides such as 224 to establish a strong bond and provide clearance of up to 0.0005 inch, for the integrated shutter body to slide smoothly on surfaces 217 and 218.

The material chosen for use in this card structure helps assure that certain requirements of the ISO standard are met. Specifically, as shown in FIGS. 34, 35, and 36, the ISO standard requires that cards be flexible enough to be deflected as shown transversely in FIG. 35, and longitudinally in FIG. 36 Displacements “y” and “x” are 2 centimeters and 1 centimeter respectively according to the ISO specifications. The card structure described above also preferably utilizes a particular combination of materials for each of the layers in the laminate structure. Other suitable material combinations include all plastic or thermo-plastic layers, layers made from Titanium, Titanium alloys, Copper, Copper alloys, Aluminum, Aluminum alloys, Magnesium and Magnesium alloys, other metals and ceramics can also be utilized. Furthermore, the thickness of the layers may be different than the thicknesses described herein. A more detailed description of the card 201 is provided in U.S. patent application Ser. No. 10/194,132, filed on Jul. 11, 2002, assigned to the assignee of the present application, which is incorporated by reference.

FIG. 37 illustrate card 201 with its IC 211 and storage volume 205. The IC includes a logic block consisting of authentication and input/output (I/O) 280, a EEPROM 281, and a cryptography engine 282. In other embodiments encryption/decryption is implemented in software on the host system or in the reader electronics as a hardware or dedicated software engine. One advantage of the described configuration is that encryption algorithms and the storage are independent of the rest of the system. Consequently, new algorithms can be implemented without redesign of other parts of or the entire system. Additionally, the illustrated approach allows each card in a family of products to have different algorithms, thereby increasing the security of the data.

A typical application for the encryption discussed above is the secure download of a large data file, such as a movie, music or confidential information. This is described next. Assuming the confidential data file is located on a secure server, the operation of card 201 and reader electronics would entail the following sequence of events. The card reader mechanism is first installed in a system that has a communication channel to the secure server. Card 201 is issued to a user and a private key is stored in secure EEPROM 281, along with a digital certificate identifying the owner of the card. In other embodiments, the digital certificate consists of biometric templates encrypted and stored on disk 205.

Once the card 201 is inserted in the reader, a sequence of challenges are initiated between the reader and the card 201, utilizing logic 280, to establish the validity of the card and the reader electronics and second between card 201 and the host system to establish a secure communication channel. Once this is complete, the host system initiates communication with the secure server. The secure server initiates another set of challenges to the card 201. The card responds in one embodiment by sending encrypted messages using the RSA algorithm and the on-board private key. The secure server decrypts the message utilizing the public key assigned to the user of the specific card. A verification of the digital certificate is also performed. Alternatively, in other embodiments, the biometrics of the user are compared to stored templates. After the authentication process is complete, the secure server encrypts a set of session keys (symmetric keys) and information regarding the sequence with which the session keys will be utilized, to encrypt the confidential data. The file is sent to the card 201 utilizing the public key. Note per the Public Key Infrastructure protocol (PKI) card 201 is the only card that can decrypt this message.

The session keys are stored in secure EEPROM 281 and the input/output logic 280 is configured to pass data to the cryptography engine 282 which performs no operation on the data stream and passes it on to the next logic block. The server then streams the encrypted data to the host system or reader.

At this point, the data stored on disk 205 is encrypted; the keys are in secure EEPROM 281, and both must operate together to reveal the stored information. In one embodiment this is achieved by a sequence where logic 280 initiates a challenge using a message encrypted with the private key and requests the host to acknowledge the request to display the data. This challenge and response sequence can also establish the validity of the communication link to enable display of the data. Upon completion of this sequence the reader mechanism directs the data from disk 205 through the cryptography engine 282 where cipher text is converted to data which is then passed on to the host system.

In an alternative method the data is transmitted encrypted from card 201 along with the encryption keys to the host in a manner similar to the secure server communication described earlier. This sequence requires that the host have a microprocessor. In this arrangement card 201 also contains the cryptography logic as software stored on disk 205. This logic is itself securely transmitted to the host and used to perform the decryption of the data. For hosts that do not have computational capability, preferably the decryption is performed by logic 282 on card 201 and delivered to the host.

In one embodiment, a multi-purpose portable electronic system includes a host device, e.g., the host device 101 of FIG. 1, and a guest device, e.g., card 150′ of FIG. 23. The cards 116, 150, 150′, and 201 illustrate various embodiments of a storage card (or card-like device) of the present invention. For purpose of illustrating the present embodiment, the card 150′ is used rather than the cards of other embodiments.

Referring back to the present embodiment, the host device is provided with video drivers, a wireless interface antenna and drivers and a connector to interface with either the IS07816 bus or the high-speed 12 pin bus of FIG. 23. In one embodiment, the card is configured as an application-specific data processing device. For example, the card may be configured to provide a mobile phone service, PDA, an MP3 player, a video player, or the like. The form factor of the card allows the user to carry a plurality of such cards. If the user wishes to use the host device as a mobile phone then a first card configured for that application specific function is inserted into the host device. Thereafter, if the user wishes to use the host device to listen to music, a second card configured for audio playback may be inserted in place of the first card, and so on. Certain cards may be provided with multiple functions; e.g., a card may be provided with a dual function of mobile phone and MP3 player. Accordingly, the host device merely is a casing for the card, and takes on the “personality” of the respective card. The card may be provided with a semiconductor memory device, such as a Flash memory 154, or a rotating magnetic disk.

In another embodiment, the card (guest device) functions as a miniature computer and the host device functions as a peripheral device, i.e., an input device for user commands and a display device for data. The card is configured to serve as a general purpose data processing system while traditional I/O devices are contained in a PC like casing.

This arrangement could be extended to devices such as desktop and notebook PCs as shown in FIG. 38. The card 150′ with the necessary electronics contains both the storage and the processing power to customize the respective box to satisfy the user need. The card with improvements in semiconductor technology can achieve superior computing power and memory to satisfy a usage environment. In one embodiment, the host device such as the one shown in FIG. 4 may be utilized to interface the card with a computer. In another embodiment, the card may be used with a reader 171 which is configured as a PC card and contains the mechanism and electronics 111 as shown in FIG. 14. The reader 171 is configured to receive a card 172 and read and write data to and from the card. The reader 171 in turn is configured to be inserted into a desktop PC 170. The reader 171 interfaces with the PC 170 though a standard PCMCIA interface in one embodiment. Other embodiments, the reader may be connected to the computer using high speed custom interfaces or the USB bus.

The card 172 includes a microprocessor, RAM, ROM, and storage, drivers, and other logic elements, as illustrated in FIG. 25. One or more different types of application software may be stored in the storage area of the card, e.g., Microsoft Word™, Lotus Organizer™, an operating system, and so on. Accordingly, the user can use and maintain his own software volume wherever he or she is. This feature is particularly useful for the mobile user.

In one embodiment, the microprocessor on the card is used to perform all the functions of a traditional Desktop, Notebook or Palm Pilot™ like computer. That is, the data processing are internalized within the card and the Desktop unit is a shell containing hardware and low level drivers to allow the Operating System residing in the card to interface with I/O devices such as the keyboard, mouse, printer and monitor. This arrangement provides an added layer of security as the user's temporary files also remain on the card and there is no “fingerprints” left on the desktop unit upon conclusion of the session. In another embodiment, the microprocessor and memory (i.e., volatile memory only) reside in the host computer while the operating system and applications are stored in the card. This arrangement allows for the use of a much faster microprocessor supported by a larger RAM memory bank for fast execution of applications. Here RAM memory is nulled upon the conclusion of each session via a hardware switch which is activated by the action of insertion and removal of the card. Furthermore, powering down the system will also ease the contents in the system RAM.

Although the preferred dimension of the card is of a credit card, the card may be provided with different dimensions particularly if the guest device (or card) is used as a miniature computer since it would need greater processing capabilities than as an application specific device. For example, the card may be provided with a dimension of 4 inches by 3 inches by 0.5 inch, i.e., no longer having a form factor of a credit card. The card also may be realized in a hard casing that is not flexible. Accordingly, such a card would be better referred to as a guest device rather than a card; however, these terms are used interchangeably herein for consistency.

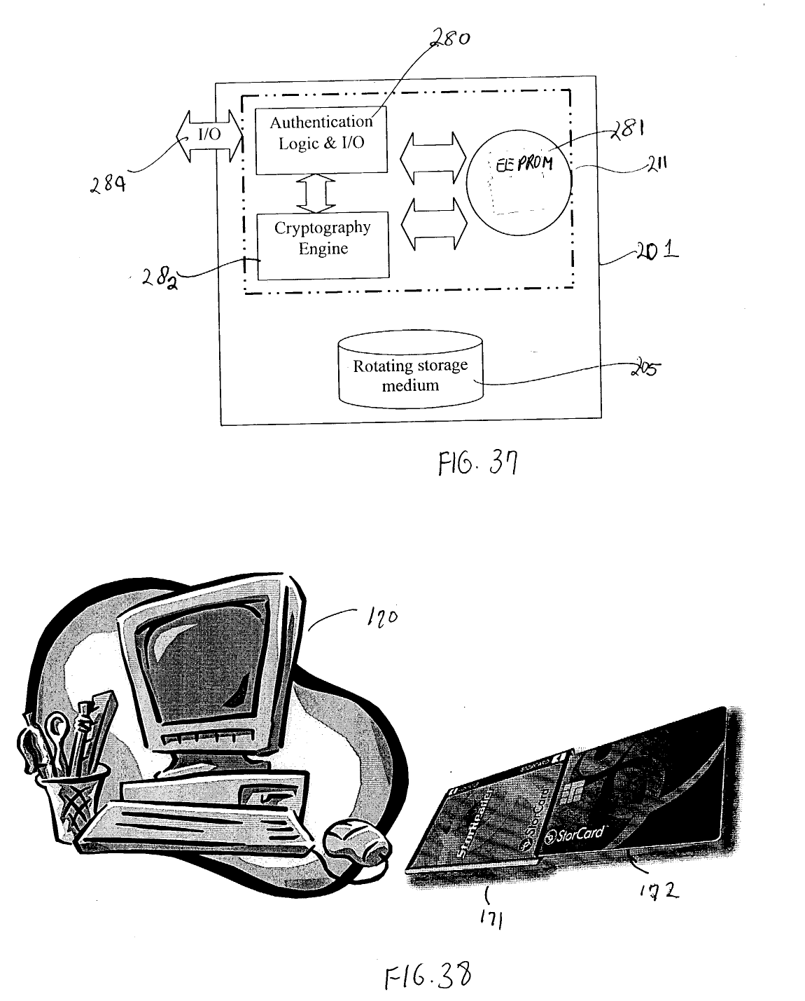

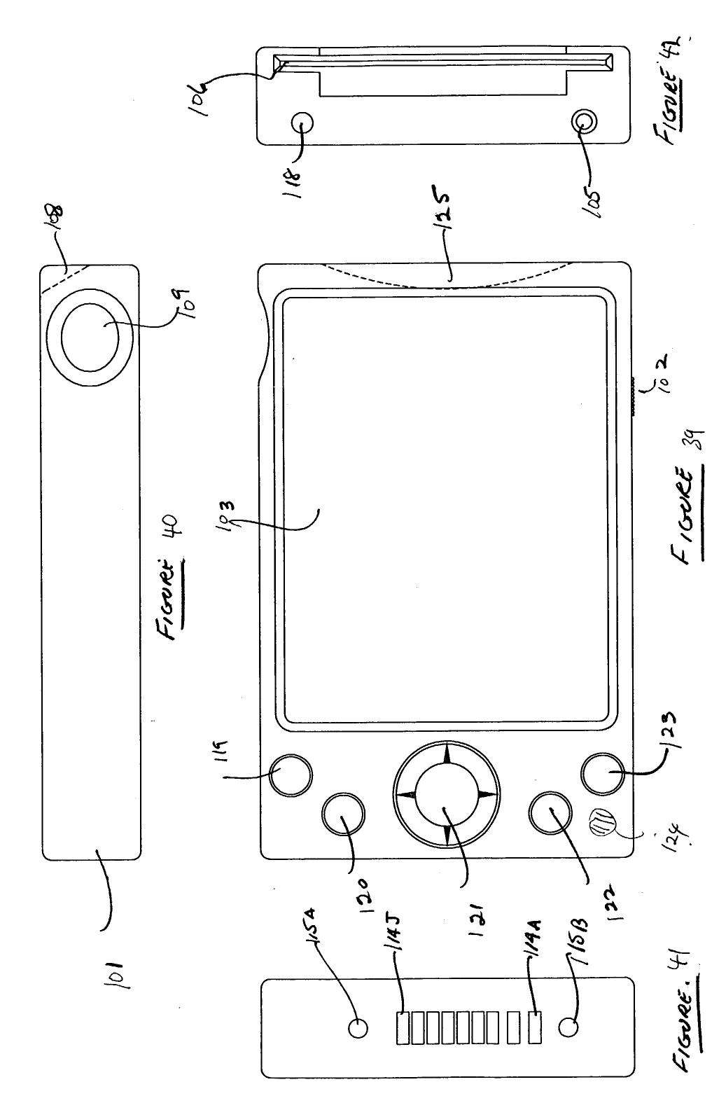

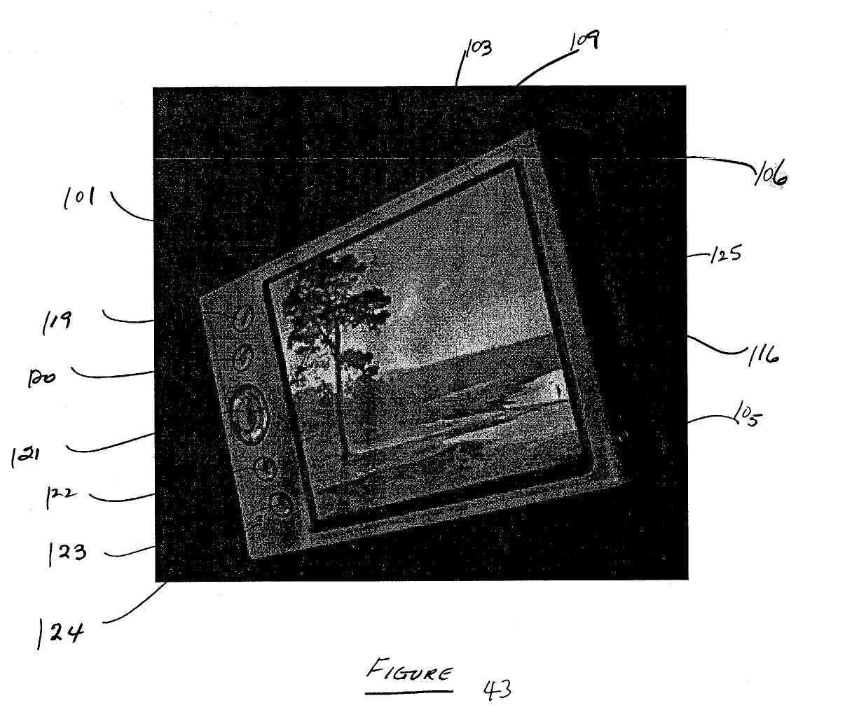

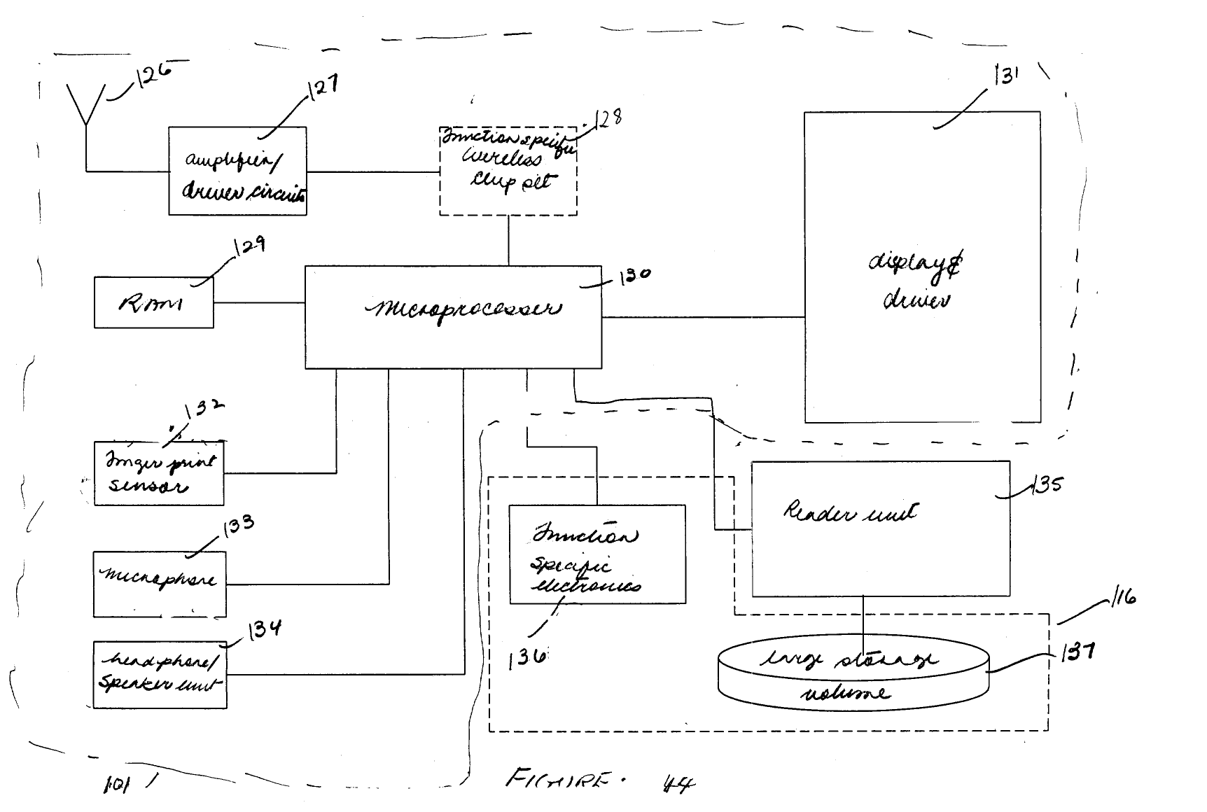

FIGS. 39-42 illustrate the plan view, side view, bottom and front view, respectively, of host device 101 according to another embodiment. In this configuration, the TFT screen is located closer to the front of the unit compared to the device illustrated in FIG. 1 and an X-Y cursor control 121 along with four buttons 119-123 are constructed. Speaker 104 is removed and microphone 124 is included. Cell phone operation in this configuration requires the use of headphones that have both speaker and microphone contacts. The headphone jack 105 and the storage card slot are located similar to the previous embodiment. Hole 118 is provided for a third party speaker to be attached to this device. This attachment could include both a speaker and a buzzer for cell phone operation. This embodiment facilitates playing video games on the unit. FIG. 43 show an isometric view of host device or digital viewer 101.

An electronic block diagram of the digital viewer according to one embodiment is shown in FIG. 44. An antenna 126 is connected to amplification and driver circuits 127 located on PCB 108. If viewer 101 were configured for cell phone operation then the specific storage card 116 is provided with a wireless chip set. If the viewer is to be configured to operate as a Bluetooth™ device or an 802.11 unit then the required electronics will be connected as a wireless chip set 128. Microprocessor 130 controls the flow of information in the viewer and provide encode/decode operations that are not implemented in hardware. RAM 129 is connected to microprocessor 130 to store dynamic parameters. The program and the session data is located in a storage volume 137 provided in the card 116. Microprocessor 130 interfaces with the reader 135 to access or record information in storage volume 137. The function unique electronics such as 128 and 136, corresponding to devices 117A and 117B of FIG. 19, are provided in the storage card 116. These are connected through the reader electronics to the appropriate circuits in PCB 108. All I/O devices such as display drivers 131, fingerprint sensor 132, microphone 133, headphone contacts/speaker 134 are connected through the respective electronic circuits to microprocessor 130.

In one embodiment, digital viewer 101 operates only when storage card 116 is installed in it. The finger print sensor along with speech biometrics can be utilized to authenticate the user prior to allowing the user to access the confidential data stored in the card. That is, the display driver is programmed to power up only when thumbprint authentication is validated.

The electronic block diagram is configurable to function as a video game player, a video recorder, a movie viewer, an MP3 player, a GPS device, a cell phone or an 802.11b wireless communicator, as explained above. In all these operations, the storage card provides both the program and the data storage according to the present embodiment. The card also contains electronics to supplement those on PCB 108 to provide multi-functionality. Another feature of this design is that viewer 101 electronics consist of I/O device drivers, and a DSP unit. The removable storage unit provides all the operational and function specific software and electronics; consequently, if communications standards change the viewer unit will not become obsolete.

In one embodiment, the screen 103 is a touch screen. When card 116 with cell phone functionality is inserted, a phone keypad is displayed on screen 103. A phone number can be dialed using a stylus. Additionally, if card 116 with PDA and handwriting recognition software is inserted into viewer 101, the touch screen can be utilized to record memos and input data. The storage volume on 116 would record and store this information. In other applications viewer 101 could be carried clipped to the belt or shirt pocket, and configured to be connected via the firewire connector 107 to a video camcorder (not shown). The storage volume on the card 116 can have 5 GB of storage or 5 hours of high quality video.

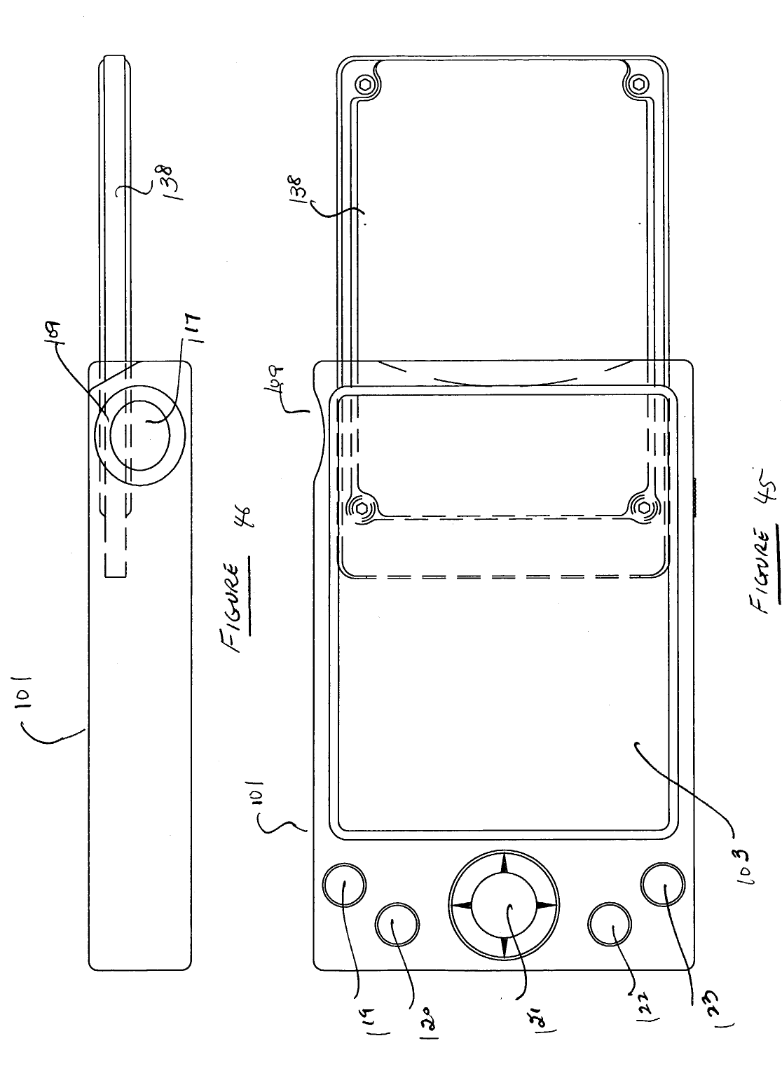

FIGS. 45 and 46 are the plan view and side views of digital viewer 101 according to another embodiment of the present invention. In this embodiment a disk drive 138, such as a PCMCIA Type II Hard Disk drive product, can be inserted into the viewer to provide storage or storage along with function specific electronics to configure the viewer as a music player, video recorder, MPEG2 player, pocket personal computer, GPS unit, etc. as the user desires.

In another embodiment, a removable volume having a flash memory storage unit or a flash memory unit with function specific electronics is used in placed of the disk drive 138. One advantage of this configuration is that it could operate in harsher environments. The cost of semiconductor memory would be significantly larger, but the operating environments may be such to justify such expenditures.

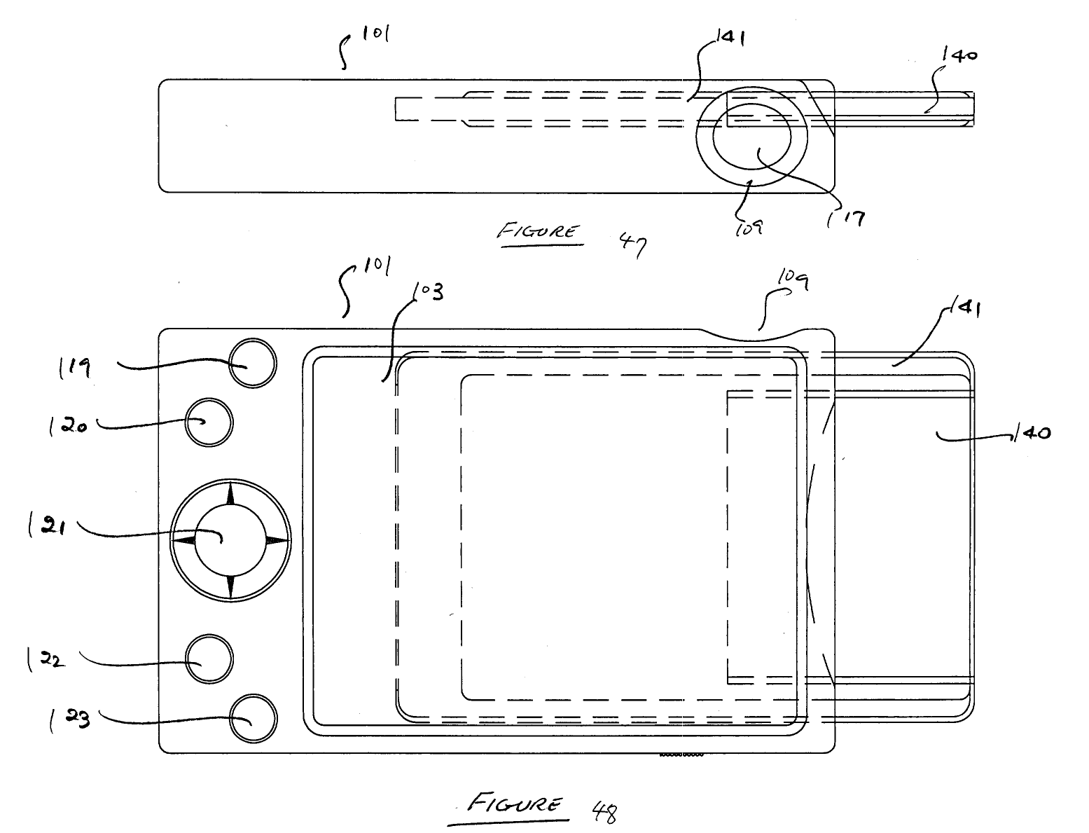

In yet another embodiment, a removable volume 140 having interface electronics or interface and function specific electronics and a small disk drive 140 is used in connection with viewer 101 (FIGS. 47 and 48). In one embodiment this disk drive is a Compact Flash form factor hard disk drive with 1.0 GB of data storage. The disk drive 140 can be constructed into card 141 or it could be made with a connector, such that it is removable from card 141. One advantage of this configuration is that data storage capacity of the digital viewer can be increased by inserting a new card or another disk drive unit.

In another embodiment as shown in FIG. 49, in plan view, is the exterior of a portable storage subsystem 301 with approximate dimensions of 4.0 inch by 2.56 inch by 0.59 inch, which includes the reader mechanism 111 illustrated in FIG. 14, and a USB or Firewire connector 305 attached via a flexible cable harness to PCB 111C. The casing of 301 has an activity LED 306 connected to 111C and a clear window 303 which indicates the presence of a card such as 116 inside the mechanism 111.

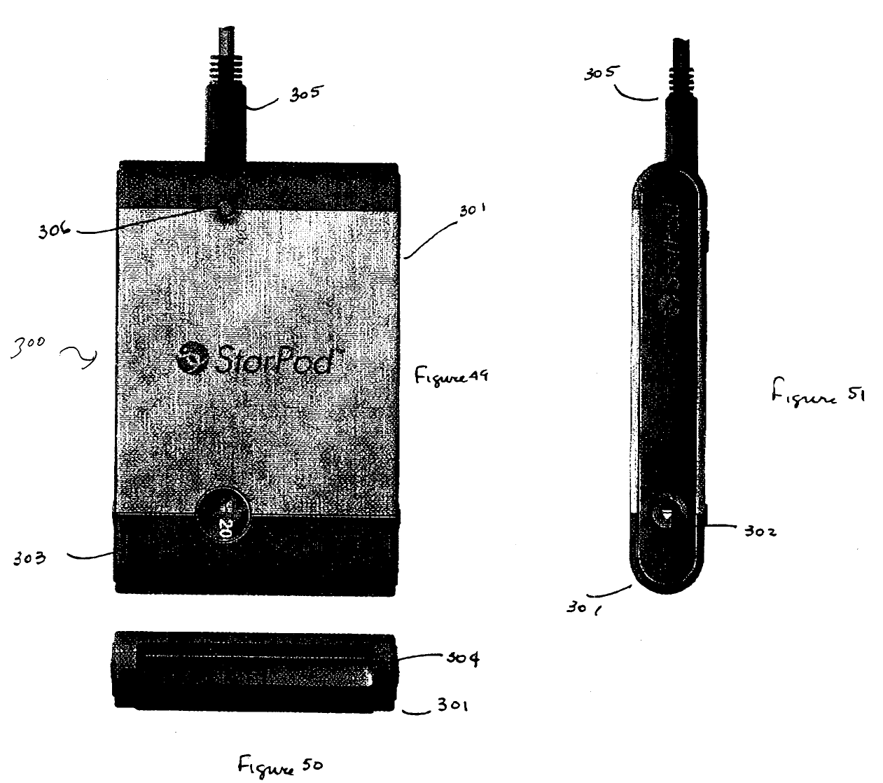

FIG. 50 shows a front view of the casing 301 and a slot 304 through which the card can be inserted and removed from mechanism 111. FIG. 51 illustrates a side view of the casing and a button 302 which when depressed ejects the card a predefined distance, e.g., 0.5 inch, to allow easy removal. The mechanism is powered via the USB interface and does not require the inclusion of a battery in 301 as the device shown in FIG. 1.

This unit serves as a storage subsystem with the guest unit containing the recording medium. This configuration is useful and provides a portable data volume that is managed by security policies contained in the IC such as 116A and can be utilized as a trusted source of information. In one implementation the unit 301 could be device C: containing the boot record or even the Operation System of a Windows™ environment that is connected to a Notebook computer, and the internal Disk Drive is configured as a slave unit device D:.

In this arrangement the Notebook computer will only boot-up and become ready only upon a valid authentication of the user. Furthermore, the data in device D: can be encrypted with keys that reside in the disk in card 116 or in the IC 116A to enforce policies and prevent a user from reconfiguring the internal Disk Drive as the master device C:. The storage volume in 116 can allow the security policies to be more elaborate than those that can be contained in a Smart Card with 34 Kbytes of EEPROM, furthermore, a transaction log file for the entire system can be created and maintained.

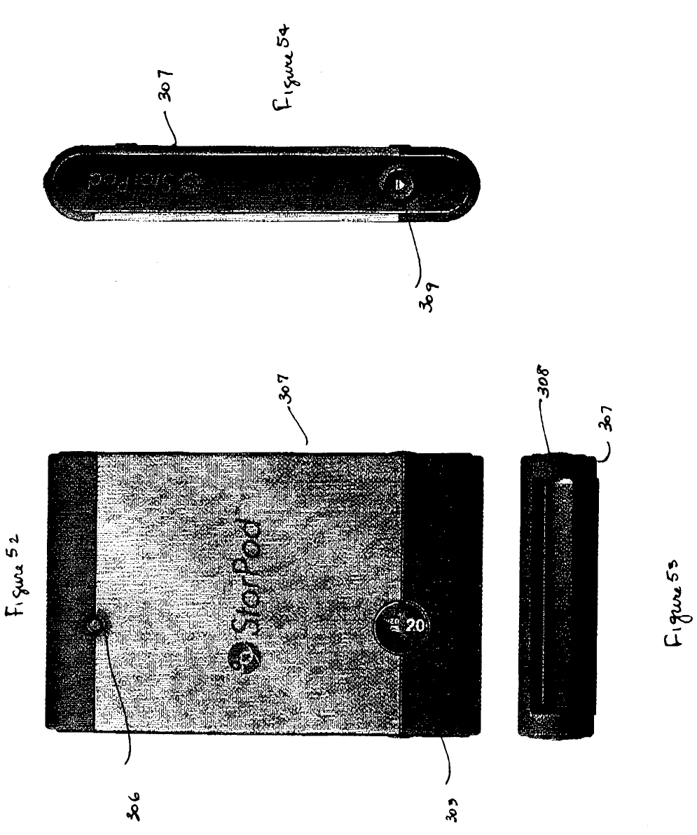

In another embodiment illustrated in FIG. 52, in plan view, the casing 307 with approximate dimensions of 4.0 inch by 2.5 inch by 0.69 inch contains the mechanism 111, a battery 112, such as a Sony model UP325385A and the PCB 108. This PCB contains digital logic that implements a wireless interface, such as BlueTooth™ or 802.11, as the interface to the mechanism 111 in a manner similar to that described for 101 and illustrated in FIGS. 4 and 6. The mechanism 111 and the digital logic on PCB 108 is powered by the local battery which can be charged using a two pin plug and a standard AC to DC converter connected to a wall power outlet. Case 307 has an activity LED 306 connected to PCB 108, and a clear window 303 which indicates the presence of the card in mechanism 111.

FIG. 53 illustrates a front view of the casing 307 and the slot 308 through which the card can be inserted and removed. FIG. 54 shows a side view of the case 307 and the eject button 309, which when depressed unloads the card and moves it a distance of about 0.5 inches outside the case 307 for easy removal. This configuration is valuable and provides a secure portable storage subsystem that could be mounted to a user's belt or clothing and could record wirelessly information from a camcorder or digital camera, or other electronic devices. Alternatively, the card such as 116 can be utilized to securely transport games and secure content that can be displayed on a user's cell phone or PDA. In the case of a cell phone, the card 116 can contain the CDMA or G3 logic as devices 117, 117A, etc. to allow such communication and supplement the digital hardware contained on PCB 108.

The present invention has been illustrated using specific embodiments. As understood, certain changes and modifications may be made to the specific embodiments illustrated above without departing from the scope of the present invention. Therefore, the embodiments disclosed above should not be used to limit the scope of the present invention. Accordingly, the following claims define the scope of the invention.

What is claimed is:

1. A portable electronic device, comprising:
a housing;
a display area provided on one side of the housing; and
a slot configured to receive an approximately credit card sized card having a first semiconductor device provided at a first location on the card and a storage area provided on a second location on the card, the first semiconductor and storage area being coupled to each other for data transfer by a data path.

2. The device of claim 1, further comprising:
an electronic component configured to receive data from the card and display images corresponding to the data on the display area.

3. The device of claim 1, wherein the device is configured to provide a specific function as required by the card inserted into the slot.

4. The device of claim 3, wherein the device is configured to take on a function of a phone, personal digital assistant, video player, video recorder, digital camera, audio recorder, audio player, or position locator, or a combination thereof according to the specific function associated with the card that is inserted into the slot.

5. The device of claim 1, further comprising:
a thumb print sensor for authenticating identity of a user.

6. The device of claim 1, further comprising:
a reader to read data stored in the storage area of the card using the first semiconductor device.

7. The device of claim 1, wherein the slot is configured to receive the card that is inserted within a reader, the reader being configured to read data stored in the storage area of the card via interconnects coupled to the first semiconductor device.

8. The device of claim 1, wherein the reader is a disk drive having a shape of a PCMCIA card.

9. The device of claim 1, wherein the storage area is a rotatable magnetic disk for storing data.

10. The device of claim 1, wherein the storage area is a second semiconductor device. 10B The device of claim 1, wherein the second semiconductor device is a Flash memory unit.

11. The device of claim 1, wherein the device uses a microprocessor provided in the card to execute one or more programs stored in the storage area of the card.

12. A multi-functional portable electronic device, comprising:
a housing;
a display area provided on one side of the housing; and
a slot configured to receive a card having a first semiconductor device provided at a first location on the card and a storage area provided at a second location on the card, the first semiconductor and storage area being coupled to each other for data transfer by a data path, the card being configured to provide an application specific function,
wherein the device is configured to provide a function according the application specific function of the card that is inserted into the slot.

13. The device of claim 12, wherein the device is configured to provide a function of a phone, personal digital assistant, video player, video recorder, digital camera, audio recorder, audio player, or position locator, or a combination thereof according to the application specific function of the card that is inserted into the slot.

14. The device of claim 12, wherein the card has an approximate size of a credit card.

15. The device of claim 12, further comprising:
a reader to read data stored in the storage area of the card using the first semiconductor device.

16. The device of claim 12, wherein the slot is configured to receive the card that is inserted within a reader, the reader being configured to read data stored in the storage area of the card via interconnects coupled to the first semiconductor device.

17. The device of claim 16, wherein the reader is a hard drive having a shape of PCMCIA card.

18. An authentication card associated with a specific user, comprising:
identification information of the specific user;
an integrated circuit accessible from an exterior of the card, the integrated circuit being provided on a first location on the card; and
a storage area provided on a second location on the card that is remote from the first location.

19. The card of claim 18, wherein storage area is a Flash memory.

20. The card of claim 18, further comprising:
a bus connecting the integrated circuit and the storage area, wherein data is stored and retrieved to and from the storage area using the integrated circuit.

21. The card of claim 18, wherein the card has a form factor of a credit card and the bus includes a flexible circuit.

22. The card of claim 18, wherein the card has a thickness of about 0.25 inch to about 0.020 inch.

23. The card of claim 18, further comprising:
a microprocessor to process data stored in the storage area; and
a plurality of semiconductor devices.

24. The card of claim 23, wherein one or more application programs are stored in the storage area.

25. The card of claim 18, further comprising:
a high speed interface coupled to the storage area.

26. The card of claim 18, wherein the card is used to authenticate the identity of a possessor of the card.

27. The card of claim 26, wherein the card is a drivers license, identification card, security card, credit card, transactional card, or debit card.

28. A method for using a card-like device, comprising:
inserting the card-like device into a host device, the card-like device having an integrated circuit provided on a first location of the card-like device and a storage area provided on a second location of the card-like that is remote from the first location, an application program being stored in the storage area of the card-like device, the card-like device having a thickness of no more than 0.25 inch; and
processing information using the application program stored in the card-like device with an input device of the host device.

29. The method of claim 28, wherein the host device is a portable digital viewer to view at least video information.

30. The method of claim 28, wherein the host device is a Notebook computer or desktop computer.
